(19) United States
(12) Patent Application Publication
(10) Pub. No.: US 2026/0316207 A1
(43) Pub. Date: Oct. 15, 2026

(54) PROTECTIVE COVER FOR CONTROL DEVICES

(71) Applicant: Bedrock Creative Innovations LLC, Westerville, OH (US)

(72) Inventors: Edward B. Deim, Centerburg, OH (US); Brandon B. Deim, Fredericktown, OH (US)

(73) Assignee: Bedrock Creative Innovations LLC, Westerville, OH (US)

(21) Appl. No.: 19/465,750

(22) Filed: Jan. 30, 2026

Related U.S. Application Data
(60) Provisional application No. 63/752,714, filed on Feb. 1, 2025.

(51) Int. Cl. B23Q 11/08

(52) U.S. Cl. CPC B23Q 11/08

(57) ABSTRACT

A protective cover for a device is disclosed. In some embodiments, the protective cover comprises a flexible elastomeric body defining a cavity configured to cover a control portion of a control device and a sleeve configured to extend along an elongated shaft. The protective cover may include a retention region and/or a high-friction interface configured to resist shifting or axial migration during manual operation. In some embodiments, the protective cover includes a switch zone aligned with a control on the control portion, the switch zone having a thickness and/or compliance selected to facilitate intentional actuation through the protective cover while reducing inadvertent activation. In some embodiments, the protective cover includes an opening feature and a closure feature configured to secure the opening feature after installation and/or a seal region configured to conform around a shaft or arm to inhibit ingress of contaminants.

### CROSS-REFERENCE TO RELATED APPLICATIONS

This application claims the benefit of U.S. Provisional Patent Application No. 63/752,714 entitled “PROTECTIVE COVER FOR CONTROL DEVICES” filed Feb. 1, 2025, the contents of which are hereby incorporated by reference.

### TECHNICAL FIELD

The present disclosure relates generally to control devices such as control arms and joysticks, and more particularly, a disposable protective cover for control devices.

### BACKGROUND

In the field of construction equipment, industrial machinery, and various hand-operated control devices, the consistent maintenance of functionality and durability of control arms and related mechanisms plays a critical role in ensuring operational efficiency and safety. Control devices commonly employed in such contexts, including but not limited to joysticks, control arms, levers, and other user interfaces found in excavators, forklifts, doorknobs, medical device interfaces, plows, simulators, spray guns, gaming devices, steering wheel covers, and pressure wands, are frequently exposed to harsh and demanding conditions. These conditions often involve significant accumulation of dirt, mud, grease, and other contaminants during routine use. A primary issue associated with such exposure is the deposition of contaminants on the surfaces of these devices, which creates slippery operating conditions, thereby increasing the likelihood of hand slippage during operation. Such incidents not only compromise user control but also heighten the risk of accidents and associated injuries, particularly in high-stakes industrial and operational settings.

Moreover, contaminants such as dirt, grease, and abrasive materials infiltrate the switches, joints, and other mechanical components of the control devices, leading to performance degradation over time. Such infiltration can result in mechanical fouling, impaired responsiveness, and, in severe cases, complete operational failure of the control device. Abrasive substances, such as sand, exacerbate this wear and tear, accelerating the deterioration of critical components and leading to increased maintenance costs and shortened equipment lifespans. These operational challenges underline the need for effective protective measures that mitigate contamination-related issues.

Additionally, similar challenges arise for medical devices that employ joystick-type remote controls, control arms, and/or control boxes, including operator consoles for robotic surgical systems and other clinical equipment. In these settings, control surfaces may be repeatedly contacted by gloved users, exposed to splashes or residues, and subject to cleaning protocols, making it desirable to provide a removable protective cover that reduces contamination of the underlying control surfaces while preserving tactile operation and consistent controllability.

The inherent design of control devices presents further complications in addressing these challenges. Control devices typically exhibit complex geometries, characterized by a relatively large control portion, often containing buttons or switches, and a narrower shaft extending downward. This structural configuration creates significant difficulties in designing protective covers that can conform snugly to the contours of the control device without being excessively tight, which may interfere with functionality, or overly loose, which may compromise stability. These difficulties are magnified in high-use environments, such as construction sites or industrial facilities, where equipment is subject to near-continuous exposure to contaminants and where frequent cleaning or maintenance of protective solutions is neither feasible nor cost-effective.

To address these challenges, there exists a need for a disposable protective cover that not only safeguards control devices from dirt, grease, and other contaminants but also ensures compatibility with a wide range of device geometries. Such a protective cover should be engineered to provide a snug and secure fit over the control device, accommodating the large control portion and narrow shaft without shifting or slipping under operational pressures. Furthermore, the protective cover should enhance operational safety by preventing hand slippage during use and extend the service life of control devices by mitigating contamination-related wear and tear.

### SUMMARY OF THE INVENTION

This disclosure relates to protective covers for devices that are frequently touched during operation, including control devices such as joysticks, control arms, and control boxes. The protective covers disclosed herein can be used to reduce soiling of device surfaces and to reduce transfer of contaminants between users and environments, while maintaining usability of the underlying device.

In some embodiments, a protective cover comprises a flexible elastomeric body defining a cavity configured to receive and cover at least a portion of a control portion of a control device and a sleeve configured to extend along an elongated shaft. In some embodiments, the protective cover includes one or more retention regions configured to resist shifting, rotation, and/or axial migration during repeated manual operation. The retention region may be provided by geometry (e.g., an internal collar, constriction, or stepped inner diameter), by localized material properties, by an interior high-friction interface, or by combinations thereof.

In some embodiments, an interior surface of the protective cover includes a high-friction interface, such as an interior texture and/or coating, configured to increase resistance to slip relative to the covered device. In some embodiments, an exterior surface includes a grip-enhancing texture comprising ribs, bumps, or surface irregularities.

In some embodiments, the protective cover includes one or more switch zones aligned with one or more controls on a control portion. A switch zone can be implemented by locally reduced thickness, locally increased compliance, a relief pocket, localized corrugations, or combinations thereof, to facilitate intentional actuation through the protective cover while reducing inadvertent activation due to incidental gripping forces. In some embodiments, regions surrounding a switch zone are relatively less compliant to inhibit unintended actuation.

In some embodiments, the protective cover includes an opening feature that facilitates installation and a closure feature configured to secure the opening feature in a closed condition after installation. The closure feature can comprise, for example, a pressure-sensitive adhesive portion (optionally with a removable release strip), an overlapping flap, hook-and-loop fastening, snaps, zippers, interlocking closures, elastic bands, drawstrings, cinch straps, heat-sealable edges, or combinations thereof. In some embodiments, overlapping portions define a tortuous path configured to inhibit ingress of contaminants through the opening feature.

In some embodiments, the protective cover is configured for a control device having a control box and a control arm, with a passage portion permitting the control arm to extend through the protective cover while the protective cover covers at least a portion of the control box. In some embodiments, a seal region is configured to conform around the control arm to inhibit ingress of contaminants toward the control box.

In some embodiments, the protective cover comprises an elastomeric material including natural rubber, synthetic rubber, latex, nitrile, silicone, thermoplastic elastomers, thermoplastic polyurethane, neoprene, or combinations thereof. In some embodiments, the protective cover includes one or more additives, coatings, or treatments selected to reduce microbial transfer and/or reduce allergenic potential, without implying any particular level of efficacy unless expressly stated. In some embodiments, the protective cover is disposable and replaceable after becoming soiled.

### BRIEF DESCRIPTION OF THE DRAWINGS

FIG. 1 exemplarily illustrates a disposable protective cover covering a control device, according to an embodiment of the present invention.

FIG. 2 exemplarily illustrates the disposable protective cover partially covering a control device, according to an embodiment of the present invention.

FIG. 3 exemplarily illustrates the disposable protective cover covering a control device having a simple joystick configuration, according to an embodiment of the present invention.

FIG. 4 exemplarily illustrates the disposable protective cover covering a control device having a T-type joystick configuration, according to an embodiment of the present invention.

FIG. 5 exemplarily illustrates a disposable protective cover, according to another embodiment of the present invention.

FIG. 6 exemplarily illustrates a disposable protective cover covering the control device, according to yet another embodiment of the present invention.

FIG. 7 exemplarily illustrates a disposable protective cover covering a control box of a control device and, in some embodiments, covering a control arm (unitary or separate covers), according to yet another embodiment of the present invention.

FIG. 8 exemplarily illustrates a disposable protective cover covering a handle of garden hand shovel, according to yet another embodiment of the present invention.

FIG. 9 exemplarily illustrates a disposable protective cover covering a handle of paint brush, according to yet another embodiment of the present invention.

FIG. 10 exemplarily illustrates a disposable protective cover covering a doorknob, according to yet another embodiment of the present invention.

FIG. 11 exemplarily illustrates a disposable protective cover covering a lever door handle, according to yet another embodiment of the present invention.

FIG. 12 exemplarily illustrates a disposable protective cover covering a steering wheel, according to yet another embodiment of the present invention.

FIG. 13 exemplarily illustrates a perspective view of the disposable protective cover of FIG. 12.

FIG. 14 exemplarily illustrates a cross-sectional view of the disposable protective cover of FIG. 12.

FIG. 15 exemplarily illustrates a disposable protective cover covering a push bar of shopping cart, according to yet another embodiment of the present invention

FIG. 16 exemplarily illustrates a perspective view of the disposable protective cover of FIG. 15.

FIG. 17 exemplarily illustrates a cross-sectional view of the disposable protective cover of FIG. 15.

### DETAILED DESCRIPTION OF EXAMPLE EMBODIMENTS

### Definitions

“About.” As used herein, the term “about” modifies a stated value by permitting a variation that may arise, for example, from manufacturing tolerances, material lot variation, measurement methods, and/or environmental conditions, and in some embodiments includes variations of ±10%, ±5%, or ±2% of the stated value.

“Configured to.” As used herein, the phrase “configured to” describes a capability or structural arrangement of a component and does not require that the component be in use at all times or in every embodiment.

“In some embodiments.” As used herein, the phrase “in some embodiments” indicates that a described feature or characteristic may be included in at least one embodiment, and does not imply that the feature is required in all embodiments.

“Control device.” As used herein, “control device” refers to a device that is manually manipulated by a user to provide input or control, and includes, by way of example, joysticks, control levers, control arms, control boxes, and similar operator interfaces. A control device may include one or more controls, such as buttons, toggles, switches, selectors, or touch surfaces.

“Control portion.” As used herein, “control portion” refers to a portion of a control device that is intended to be contacted by a user during operation and may include one or more controls.

“Shaft.” As used herein, “shaft” refers to an elongated portion extending from the control portion, and may be straight, curved, or angled, and may have constant or varying cross-sectional dimensions.

“Transition.” As used herein, “transition” refers to a region where an outer geometry, cross-sectional size, or contour changes between the control portion and the shaft, including an interface that forms a shoulder, step, taper, fillet, or undercut.

“Retention region.” As used herein, “retention region” refers to a region of a protective cover that increases resistance to relative movement between the protective cover and a covered device, including resistance to axial migration and/or rotation. A retention region may be formed by geometry (e.g., an internal collar, constriction, or stepped inner diameter), material properties (e.g., higher modulus), surface properties (e.g., increased friction), or combinations thereof.

“Axial migration.” As used herein, “axial migration” refers to movement of a protective cover along a longitudinal axis of a shaft or along a direction generally parallel to the shaft, including sliding, creeping, or displacement during use.

“High-friction interface.” As used herein, “high-friction interface” refers to an interior surface region of a protective cover that provides increased resistance to slip relative to a covered device, as compared to an untreated or untextured interior surface of the same material, and may be provided by texture, coating, tackifier, or combinations thereof.

“High-friction” (and “high-friction interface”), as used herein, refers to a surface, surface region, or interface of the protective cover that provides increased resistance to slip relative to a contacted device surface as compared to an otherwise similar protective cover surface lacking the referenced texture, coating, tackifier, or treatment, under comparable contact conditions. High-friction may be achieved by surface topography (e.g., ribs, dimples, bumps, or microtexture), by a coating or tackifier, by material selection, or by combinations thereof, and does not require any particular coefficient of friction unless expressly stated.

“Texture.” As used herein, “texture” refers to a non-smooth surface topography, which may include ribs, ridges, dimples, bumps, grooves, or other surface irregularities. Texture may be disposed on an exterior surface, an interior surface, or both.

“Switch zone.” As used herein, “switch zone” refers to a region of a protective cover aligned with a control (e.g., a button, switch, toggle, or selector) and configured to facilitate intentional actuation through the protective cover while reducing interference with intended control operation. In some embodiments, a switch zone is defined by locally reduced thickness, locally increased compliance, a relief pocket, localized corrugations, or combinations thereof, relative to adjacent regions of the protective cover.

“Adjacent region.” As used herein, “adjacent region” refers to a region of a protective cover proximate a referenced region (e.g., a switch zone), and may be immediately next to or surrounding the referenced region, including circumferentially and/or longitudinally adjacent portions.

“Seal region.” As used herein, “seal region” refers to a region of a protective cover configured to conform around a feature (e.g., a control arm, shaft, or cable) to inhibit ingress of contaminants. A seal region may be formed by an aperture sized to provide radial compression, a lip, a gasket-like geometry, an elastomeric band, or combinations thereof.

“Opening feature.” As used herein, “opening feature” refers to a structure that permits installation of the protective cover onto a device, including a slit, seam, separable overlap, stretch opening, or combinations thereof.

“Closure feature.” As used herein, “closure feature” refers to a structure configured to secure an opening feature in a closed condition, including pressure-sensitive adhesive, removable release liners, hook-and-loop fasteners, snaps, zippers, interlocking closures, elastic bands, drawstrings, cinch straps, heat-sealable edges, or combinations thereof.

“Tortuous path.” As used herein, “tortuous path” refers to a non-linear path formed by overlapping, folding, or multi-layered structures that increases the distance and/or complexity of a route by which contaminants could pass through an opening feature.

“Contaminants.” As used herein, “contaminants” includes, by way of example, dust, dirt, grease, oils, liquids, moisture, and biological materials that may soil a device or be transferred by touch.

“Reduce microbial transfer.” As used herein, “reduce microbial transfer” means reducing a probability or extent of transfer of microorganisms from a contacted surface relative to an otherwise similar protective cover lacking the referenced additive, coating, or treatment, under comparable contact conditions; the phrase does not require sterilization or any specific log reduction unless expressly stated.

“Antimicrobial agent.” As used herein, “antimicrobial agent” refers to a substance incorporated into, coated onto, or otherwise associated with the protective cover that inhibits growth and/or viability of microorganisms under selected conditions, and may include bacteriostatic and/or bactericidal agents. The term does not imply efficacy against viruses unless expressly stated.

As used herein, an “antiviral additive” refers to a substance incorporated into, coated onto, or otherwise associated with the protective cover that is selected to reduce viral viability and/or reduce viral transfer under selected formulations and testing conditions, without implying any particular level of efficacy unless expressly stated.

“Allergen-reducing feature.” As used herein, “allergen-reducing feature” refers to a material selection, coating, liner, formulation, or treatment configured to reduce allergenic potential and/or reduce exposure to allergen-containing components (e.g., latex-related allergens), and does not require complete elimination of allergens unless expressly stated.

“Disposable.” As used herein, “disposable” refers to a protective cover intended for replacement after a limited period of use, which may be a single use or multiple uses, and may be replaced after becoming soiled, damaged, or contaminated.

“Service life.” As used herein, “service life” refers to an anticipated duration of use of a protective cover under typical operating conditions before replacement, and may vary based on contamination exposure, environmental conditions, and user handling.

Although the embodiments described herein are illustrated in the context of control devices, the disclosed protective covers share common structural features (including a flexible cover body, optional retention regions and/or high-friction interfaces that resist shifting, optional switch zones that preserve intended actuation, and optional opening/closure and seal regions that inhibit contaminant ingress) that may be applied, individually or in combination, to a wide variety of hand-contacted devices.

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

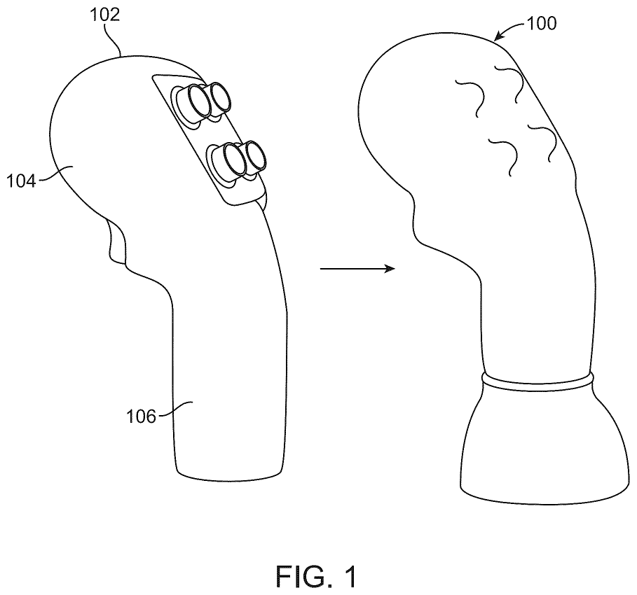

Referring to FIG. 1 through FIG. 4, the present invention discloses a protective cover (100, 200, 300, 400) designed for use with control devices 102. The protective cover (100, 200, 300, 400) is characterized by its cost-effectiveness, durability, and disposability, and is specifically configured to protect control devices 102 and related mechanisms from dirt, grease, abrasive materials, and wear. Control devices 102, as used herein, encompass various manually operated mechanisms and interfaces utilized to regulate, direct, or manipulate the functionality of equipment, machinery, or systems. Examples of such control devices include, but are not limited to, control arms, joysticks, pressure wands, spray guns, electronic levers, simulation equipment such as gaming and training joysticks, control mechanisms for scissor lifts, handheld tools for precision or mechanical tasks, and similar components commonly integrated into heavy machinery, such as excavators, forklifts, plows, and various industrial and construction tools. Typically, these control devices 102 feature a control portion 104, which often houses one or more control buttons, and a shaft 106 extending from the control portion 104. The control portion 104 generally forms the topmost section of the control device 102.

In some embodiments, the protective cover includes one or more retention regions configured to resist axial migration of the cover relative to the control device during repeated manual manipulation. By way of example, the protective cover may include an internal constriction region, an internal collar, or a stepped inner diameter sized to engage a transition region between the control portion 104 and the shaft 106. In certain embodiments, the retention region is positioned proximate the lower perimeter of the control portion 104 (e.g., near a shoulder or undercut of the control portion) such that operational pushing, pulling, twisting, or gripping forces tend to seat the cover rather than dislodge it.

In some embodiments, an interior surface of the protective cover includes a high-friction interface configured to increase resistance to slip relative to the control device. The high-friction interface can be provided by an interior texture (e.g., micro-ribs, dimples, or a matte surface finish), an interior coating, or a localized band of higher-friction material. In certain embodiments, the interior texture is directional (e.g., ribs oriented circumferentially or helically) to resist downward migration along the shaft 106 while still permitting installation over the control portion 104.

In some embodiments, the retention region and/or high-friction interface are provided in a localized area rather than uniformly across the protective cover, thereby enabling the protective cover to remain easy to install while achieving improved retention during use.

In some embodiments, the protective cover (or at least a portion thereof) is optically transparent or translucent to permit an operator to visually observe underlying controls, including buttons, switch positions, legends, icons, labels, indicators, and/or backlit features on the control portion. For example, the protective cover may include a transparent window region aligned with one or more controls, or the protective cover may be formed substantially entirely of a transparent or translucent elastomeric material. In some embodiments, the transparent or translucent region is provided in combination with one or more switch zones to facilitate intentional actuation through the protective cover while allowing the operator to see the underlying control features, and the region may include an anti-fog and/or anti-glare surface treatment to maintain visibility under humid or brightly lit conditions.

The protective cover (100, 200, 300, 400) is configured to accommodate various shapes and sizes of control devices (102). Its configuration ensures a snug fit at the top control portion (104), thereby preventing slippage or shifting under hand pressure, while also providing sufficient coverage for the shaft (106). Such a design shields the control device from contaminants such as dirt, grease, and abrasive materials without compromising its functionality. Similarly, the protective cover (400) is tailored to fit control devices (102) with control boxes (402), offering a secure fit that prevents movement during operation and providing complete coverage for the control box (402) to protect it from external contaminants. By ensuring compatibility with a wide range of control device geometries, the protective cover enhances operational reliability and extends the lifespan of the covered devices.

In some embodiments, the protective cover is configured to preserve tactile actuation of one or more controls (e.g., switches, buttons, toggles) located on the control portion 104 while reducing inadvertent activation caused by excessive localized pressure from the cover material. For example, the protective cover may include one or more defined “switch zones” aligned with corresponding controls of the control device, wherein the switch zones are configured to provide reduced actuation force relative to adjacent regions of the cover. In certain embodiments, the switch zones are provided by locally reduced thickness, locally increased compliance, a relief pocket, localized corrugations, or other geometric features that promote controlled deformation when a user intentionally actuates a switch through the cover.

Conversely, in some embodiments, regions of the protective cover surrounding the switch zones are configured to be relatively less compliant (e.g., thicker wall sections, ribs, or locally higher-modulus material) to resist inadvertent actuation from incidental gripping forces. In this manner, the protective cover can simultaneously (i) remain snug enough to resist shifting and slipping during operation, and (ii) avoid exerting excessive pressure that would unintentionally trigger controls or interfere with intended device operation.

In another embodiment, the protective cover (100, 200, 300, 400) is manufactured using a combination of latex and nitrile. The specific properties of latex, such as elasticity and stretchability, are complemented by the enhanced chemical and puncture resistance of nitrile, creating a material combining elasticity and durability that is both durable and versatile. An alternative embodiment incorporates a material composition consisting of 10% to 90% synthetic rubber and 90% to 10% natural rubber, enabling customization of the material's properties based on the intended application and environmental conditions.

In some embodiments, the protective cover is formed as a thin-walled elastomeric body having a nominal wall thickness selected to balance durability, tactile control actuation, and ease of installation. By way of example only, the nominal wall thickness may be in a range from about 0.1 mm to about 2.0 mm, and in certain embodiments from about 0.2 mm to about 1.2 mm. In embodiments including switch zones, the wall thickness in a switch zone may be reduced relative to an adjacent region (e.g., by at least about 10%, at least about 20%, or at least about 30%) to facilitate intentional actuation through the cover.

In some embodiments, the protective cover is configured to elastically expand to accommodate the control portion 104 and return to a retained position that resists shifting. By way of example only, the protective cover may be configured to accommodate elongation of at least about 150%, at least about 250%, or at least about 400% in one or more directions, depending on the intended control device geometry. In some embodiments, the protective cover includes a localized retention region configured to provide increased radial compression relative to adjacent portions of the cover.

In some embodiments, the interior surface of the protective cover has a surface texture or coating configured to increase friction against the control device. For example, the interior surface can include microtexture features having characteristic heights in a range from about 10 microns to about 1000 microns, or an interior tacky coating selected to increase resistance to migration along the shaft 106 during repeated hand pressure and movement.

One particular embodiment of the protective cover (100, 200, 300) is a stretchable one-piece cover, designed to expand and conform snugly over both the control portion 104 and the shaft 106. The stretchable nature of the cover ensures a secure fit while preventing the cover from shifting during use. This design also facilitates easy installation and removal, making it practical for disposable use in high-contamination environments.

In some embodiments, the protective covers described herein are particularly useful for medical devices that include operator controls having a control portion and a shaft and/or similar hand-contacted interfaces, including joystick-type controls, control arms, and control boxes used in clinical environments. By way of example, operator consoles and remote controls for robotic surgical systems and other medical equipment may include joystick-like hand controls and/or switch-bearing control portions that are repeatedly contacted by clinicians and staff during use, set-up, and post-procedure handling.

In such environments, it can be important to reduce contamination of frequently touched control surfaces and to reduce transfer of contaminants between users, equipment, and work areas, while maintaining reliable tactile operation of the underlying controls. In some embodiments, the protective cover provides a compliant, high-friction exterior surface that improves grip and controllability during extended use and while wearing gloves. In some embodiments, retention regions and/or interior high-friction interfaces resist cover shifting during repeated manipulation, and switch zones facilitate intentional actuation through the cover while reducing interference with intended control operation. In some embodiments, an opening/closure feature and/or seal region inhibits ingress of fluids and debris into seams or interfaces of the protective cover and the underlying control device, and the protective cover is disposable and replaceable between uses or users.

Referring to FIG. 1 through FIG. 7, the present invention encompasses a protective cover (100, 200, 300, 400) that is configured to accommodate a variety of control devices 102 exhibiting diverse geometries. These control devices, which are commonly used in the operation of equipment across numerous industries, include configurations ranging from traditional joystick controllers with multiple switches to more specialized designs such as T-type joystick controllers. The protective cover (100, 200, 300, 400) is adaptable to these varying geometries while ensuring a secure fit and protection against contaminants, wear, and environmental exposure.

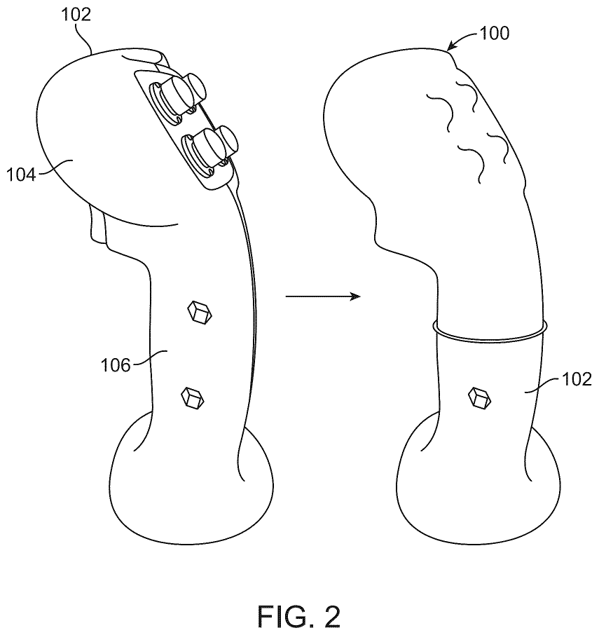

In FIG. 1 and FIG. 2, a representative embodiment is illustrated where the protective cover 100 is applied to a typical joystick controller featuring an array of switches. The protective cover 100 conforms to the contours of the control device 102, covering the control portion and shaft with sufficient elasticity to maintain a snug fit without shifting during operation. This configuration prevents the accumulation of dirt, grease, and other contaminants on the exposed surfaces of the control device 102, thereby reducing maintenance needs and extending the lifespan of the device.

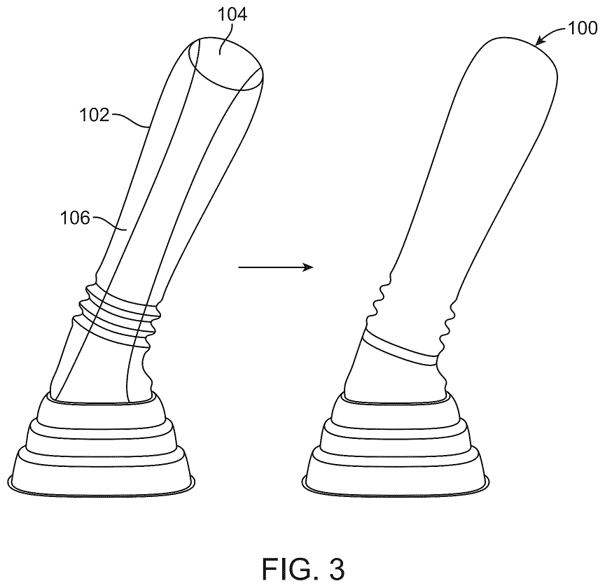

FIG. 3 illustrates another embodiment where the protective cover 100 is configured to accommodate a control device 102 with a simple joystick configuration. The design of the protective cover 100 ensures a balance between ease of installation and a secure fit, which is an important parameter for maintaining operational reliability. The stretchable material of the protective cover allows it to expand over the control portion and shaft while providing adequate protection against contaminants and preventing accidental activation of control switches.

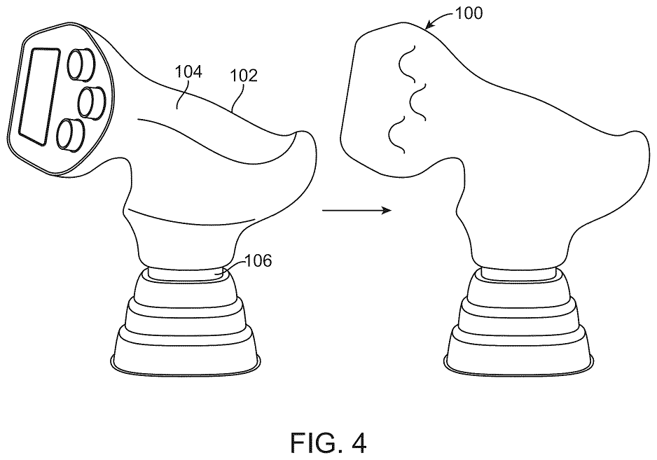

In FIG. 4, the protective cover 100 is shown applied to a T-type joystick configuration, which presents specific geometric challenges due to its dual-handle design. The protective cover 100 is specifically engineered to conform to such complex shapes, ensuring that both handles and the central shaft are adequately covered. This embodiment highlights the versatility of the protective cover (100, 200, 300, 400) in adapting to unconventional geometries while maintaining its protective and functional properties.

Alternative embodiments of the protective cover (100, 200, 300, 400) may include additional features to enhance usability and protection. For instance, a version of the protective cover may incorporate ribs, bumps, or textured surfaces to improve grip and reduce the likelihood of hand slippage during use. Another variation may include an adhesive portion or fasteners at the opening of the cover to ensure a tighter seal around the base of the control device, providing additional protection against contaminants infiltrating the device's internal mechanisms.

In some embodiments, the protective cover enhances controllability of the underlying control device by increasing effective grip in the presence of dirt, grime, grit, or mud. For example, the elastomeric material and/or exterior grip texture can provide a higher-friction, more compliant contact surface than a hard plastic control, such that particulate contamination that would otherwise form a slippery layer on the control portion is less likely to cause hand slippage. In some embodiments, the elastomeric surface conforms locally around particulate contamination, thereby maintaining a more stable hand interface and enabling more precise and consistent control inputs during operation.

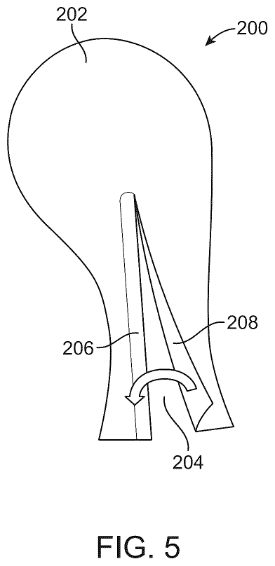

Referring to FIG. 5, an alternative embodiment of the protective cover 200 is disclosed, comprising a cover portion 202, an opening portion 204, and an adhesive portion 206 positioned proximal to the opening portion 204. The cover portion 202 is designed to envelop the control device 102, providing protection against dirt, grease, and other contaminants. The opening portion 204 facilitates the encasement of the protective cover 200 over the control device 102, while the adhesive portion 206 ensures that the opening portion 204 remains securely fastened, thereby maintaining a snug fit over the control device 102 during operation. The adhesive portion 206 can include an adhesive tape, such as a double-sided tape, covered by a removable plastic strip. When the protective cover 200 is applied, the plastic strip is removed, allowing the adhesive to secure the opening portion 204.

In some embodiments, the opening portion 204 comprises a slit, seam, or separable overlap that permits lateral placement of the protective cover around a portion of the control device, followed by sealing to inhibit ingress of contaminants. In certain embodiments, the opening portion 204 is formed as an overlapping flap arrangement that, when closed, provides a tortuous path against dirt, grease, or moisture intrusion. The extent of overlap may be selected based on the expected contamination environment, and can be increased to enhance sealing robustness while maintaining ease of installation.

Although the adhesive portion 206 is illustrated as adhesive tape covered by a removable strip, other closure mechanisms may be used alone or in combination with adhesive. Non-limiting examples include hook-and-loop fasteners, snap features, zipper features, interlocking rib-and-groove closures, elastic bands, drawstrings, cinch straps, reusable pressure-sensitive adhesive, heat-sealable edges, or combinations thereof. In some embodiments, the closure mechanism is configured to be operable while wearing gloves and/or in wet or greasy conditions.

In some embodiments, the portion 208 adjacent to the opening portion 204 includes a pull tab or reinforced edge to facilitate rapid closure, and may include a stiffened region configured to promote consistent alignment of the opening portion 204 during sealing.

To further enhance its utility, a portion 208 of the protective cover 200 adjacent to the opening portion 204 is configured to be pulled and pressed over the adhesive portion 206, ensuring a tight seal. This design simplifies the installation process, even on control devices 102 with complex geometries, such as those featuring irregular shapes or protruding components. The use of an adhesive mechanism reduces the likelihood of the protective cover 200 slipping or detaching during use, ensuring reliable performance in high-use environments.

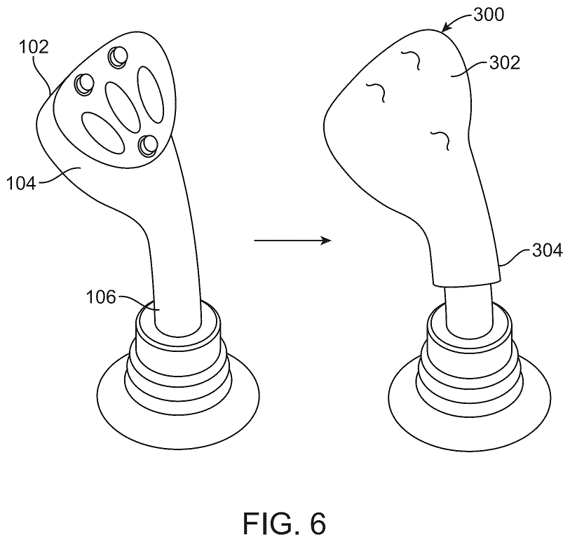

Referring to FIG. 6, another embodiment is depicted wherein the protective cover 300 includes a cover portion 302 and a skirt portion 304. The cover portion 302 is configured to snugly conform around the control portion 104 of the control device 102, preventing movement or slippage under hand pressure. The skirt portion 304 extends downward from the cover portion 302 and is configured to hang loosely, resembling a shower curtain. This unique design prioritizes protection against contaminants such as dirt and grease while eliminating the need for a tight fit around the shaft 106 of the control device 102. By allowing the skirt portion 304 to hang freely, this embodiment accommodates variations in shaft geometry and provides an aesthetically distinctive appearance.

Alternative configurations of the protective cover 200 and 300 may include variations in material composition, fastening mechanisms, or functional features. For instance, the adhesive portion 206 could be replaced or supplemented with mechanical fasteners, elastic bands, or other securing means to enhance reusability or adaptability. Similarly, the skirt portion 304 of the protective cover 300 could be fabricated from a semi-rigid material to offer additional protection against impact or abrasion.

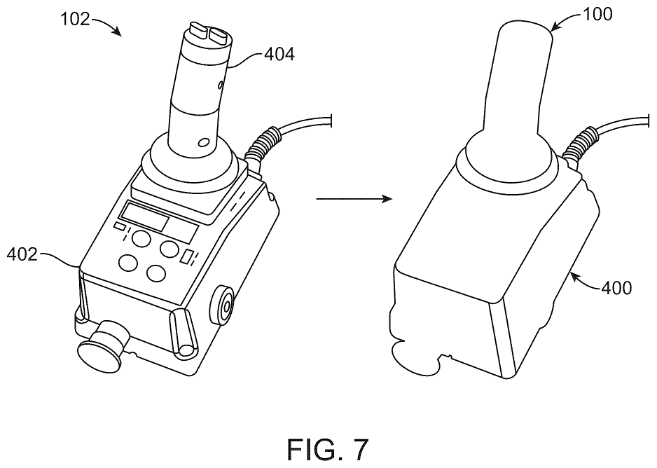

Referring to FIG. 7, an additional embodiment of the protective cover (100, 200, 300, 400) is disclosed, wherein the protective cover is configured to safeguard a control device 102 comprising a control box 402 and a control arm 404. The protective cover 400 includes an opening dimensioned to allow the cover to pass through the control arm 404, ensuring a secure and snug fit over the control box 402. In some embodiments, the protective cover 400 is a unitary cover that includes (i) a control-box portion configured to cover the control box 402 and (ii) an arm portion configured to cover at least a portion of the control arm 404, with the arm portion optionally including an aperture and/or seal region that conforms around the control arm 404 to inhibit ingress of contaminants toward the control box 402. In other embodiments, the protective cover comprises separate components, including a first cover configured to cover the control box 402 and a second cover configured to cover at least a portion of the control arm 404. Following the installation over the control box 402, the protective cover (400) is extended and encased to fully cover the control arm 404. This configuration provides comprehensive protection against contaminants such as dirt, grease, and moisture, thereby reducing wear and tear and enhancing the longevity of both the control box 402 and the control arm 404. The adaptable design ensures compatibility with a variety of control device geometries, making it suitable for diverse industrial, medical, and consumer applications.

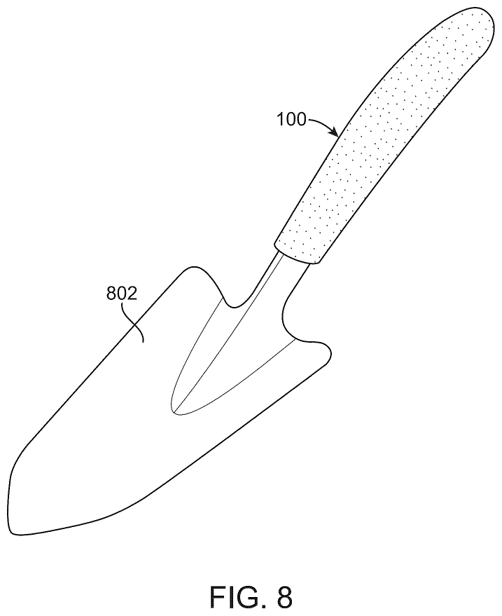

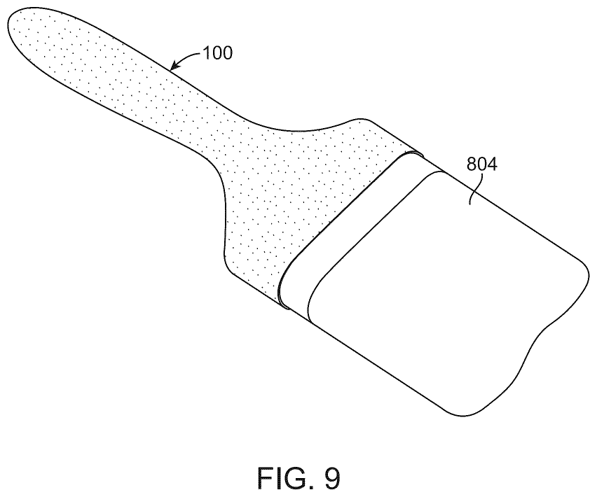

Referring to FIG. 8 and FIG. 9, an alternative embodiment of the protective cover (100, 200, 400) is shown, where the cover is configured to protect the handles of tools, including, but not limited to, a garden hand shovel 802 and a paintbrush 804. The protective cover in these embodiments provides a snug and secure fit around the tool handles, preventing the accumulation of contaminants and enhancing the user's grip during operation. This embodiment is particularly useful in environments where tools are frequently exposed to dirt, grease, or paint, offering a disposable and hygienic solution to maintain tool cleanliness and usability.

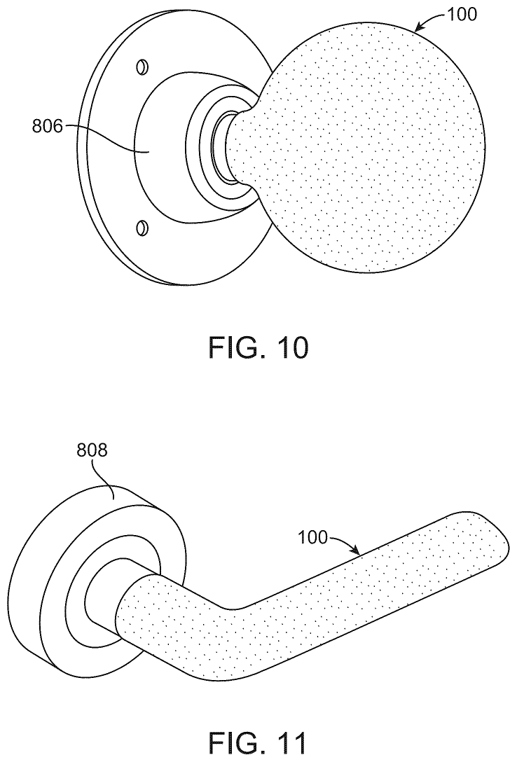

Referring to FIG. 10 and FIG. 11, yet another embodiment of the protective cover (100, 200, 400) is disclosed, wherein the cover is configured to protect handles, including but not limited to, doorknobs 806 and lever door handles 808. The protective cover in these instances is designed to conform to the geometry of the handle, ensuring a secure fit while providing protection against contaminants and reducing the transfer of germs in high-traffic areas. These embodiments are particularly advantageous in public buildings, healthcare facilities, restaurants, and similar environments where maintaining hygiene is of paramount importance.

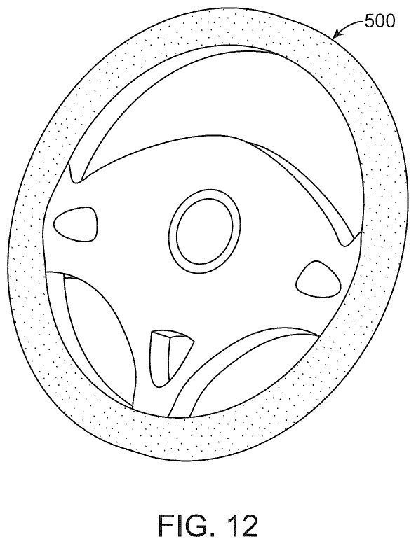

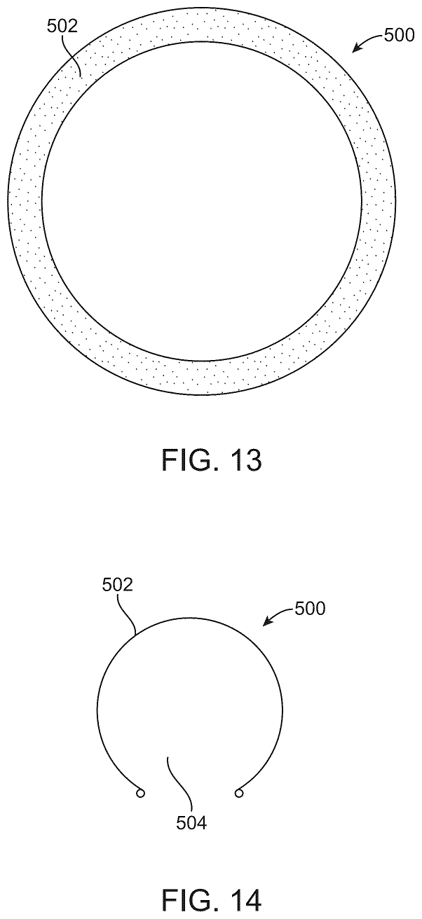

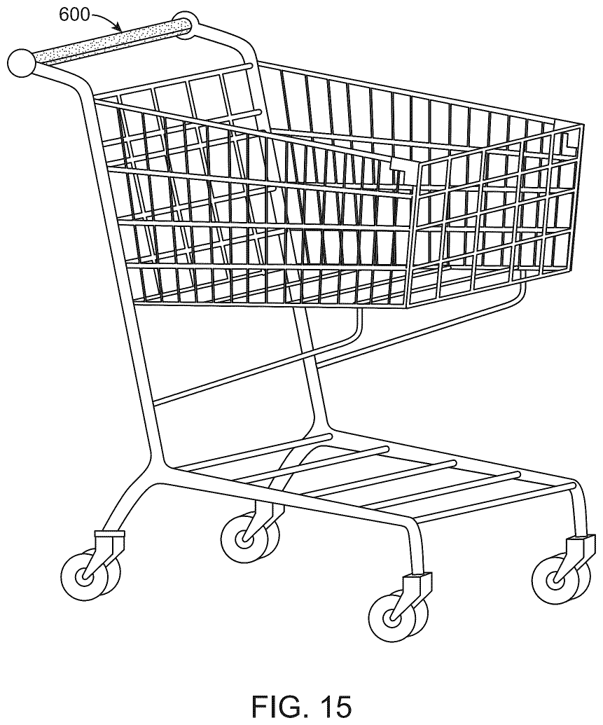

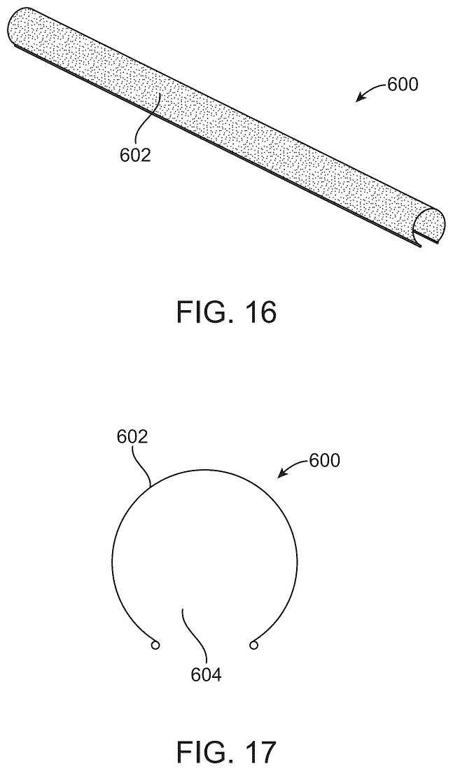

Referring to FIG. 12 to FIG. 14, in yet another embodiment, a disposable protective cover 500 is configured to cover a steering wheel. Referring to FIG. 15 to FIG. 17, in yet another embodiment, a disposable protective cover 500 is configured to cover a push bar of a shopping cart. The cover (500, 600) comprises a cover portion 502, and an opening portion 504. The cover portion 502 is designed to envelop the steering wheel, and push bar, providing protection against dirt, grease, and other contaminants. The opening portion 504 facilitates the encasement of the protective cover (500, 600) over the steering wheel, and push bar.

In addition to its protective features, the protective cover (100, 200, 300, 400, 500, 600) may incorporate antiseptic agents directly within the material composition, such as within the latex or rubber formula. Such agents may be included to reduce microbial transfer on contacted surfaces and/or to provide antimicrobial performance under selected formulations and testing conditions, without implying any particular level of efficacy unless expressly stated. Such properties are especially advantageous in environments like medical facilities, retirement homes, public buildings, and private homes, offering an added layer of protection against the spread of infectious diseases. The incorporation of these agents enables the protective cover to serve as a disposable, single-use solution that can be replaced frequently, ensuring consistent hygiene standards.

In some embodiments, the protective cover further includes an antiviral additive selected to reduce viral viability and/or reduce viral transfer under selected formulations and testing conditions. Non-limiting examples of antiviral additives include metal-based antiviral agents, polymer-bound antiviral agents, and antiviral surface treatments or coatings. The inclusion of an antiviral additive may be used alone or in combination with antimicrobial agents, without implying any particular level of antiviral efficacy unless expressly stated.

By way of example, in embodiments manufactured by dip molding, an antimicrobial additive may comprise powdered copper dispersed in a dipping solution used to form the elastomeric body. In some embodiments, the powdered copper is maintained in suspension and becomes incorporated into the cured elastomeric matrix during dipping, optionally with a coupling agent and/or binder to promote retention of copper particles within the material. In certain embodiments, copper particles are concentrated at or near an exterior surface and/or an interior surface of the protective cover to increase contact effectiveness while maintaining the desired elasticity and tactile performance.

In some embodiments, antimicrobial performance is provided by metal-based antimicrobial agents, including copper-based agents and silver-based agents, incorporated into the elastomeric body and/or disposed in a coating. By way of example, in dip-molding processes, a copper-based antimicrobial agent (e.g., copper particles, copper oxide, copper salts, or combinations thereof) may be dispersed in a dipping solution at a concentration from about 0.1 g/L to about 50 g/L, and in certain embodiments from about 0.5 g/L to about 20 g/L. By way of further example, a silver-based antimicrobial agent (e.g., silver particles, silver salts, silver ion carriers, or combinations thereof) may be dispersed in the dipping solution at a concentration from about 0.001 g/L to about 2 g/L, and in certain embodiments from about 0.01 g/L to about 0.5 g/L. In some embodiments, copper-based and silver-based antimicrobial agents are used together in the dipping solution, for example with a copper: silver concentration ratio in a range from about 200:1 to about 2:1, and in certain embodiments from about 100:1 to about 5:1. After curing, the resulting elastomeric body may include, by way of example, a copper-based antimicrobial agent in an amount from about 0.1 wt % to about 10 wt % (and in certain embodiments from about 0.25 wt % to about 5 wt %) and/or a silver-based antimicrobial agent in an amount from about 10 ppm to about 5000 ppm (and in certain embodiments from about 50 ppm to about 2000 ppm), depending on process conditions and desired performance. In some embodiments, one or more binders, dispersants, surfactants, and/or coupling agents are used to maintain suspension in the dipping solution and/or to promote retention of metal particles within the cured elastomeric matrix. In some embodiments, the metal-based antimicrobial agent is dispersed throughout the elastomeric body; in other embodiments, the metal-based antimicrobial agent is concentrated at or near an exterior surface and/or an interior surface of the protective cover to increase contact-based antimicrobial performance while maintaining desired elasticity and tactile performance.

Additionally, in some embodiments, the protective cover (100, 200, 300, 400, 500, 600) includes one or more allergen-reducing features selected to reduce allergenic potential and/or reduce exposure to latex-related allergens, including by using non-latex materials, powder-free formulations, barrier coatings, and/or liners. This dual functionality, combining enhanced sanitation with reduced allergenic properties, significantly broadens the applicability of the protective covers to environments where controlling the spread of disease and accommodating latex sensitivities are important. Such environments include medical facilities, public buildings, restaurants, and private homes, where hygiene and allergen reduction are significant. The ability to protect surfaces such as doorknobs 806 and handles, while simultaneously mitigating the risk of allergic reactions, renders the protective covers versatile and suitable for widespread use. In shop and maintenance areas, where grease and dirt are frequently transferred, the protective covers further enhance hygiene by preventing contamination of commonly touched surfaces, ensuring cleanliness and reducing cross-contamination.

In some embodiments, the protective cover is manufactured using processes suitable for thin-walled elastomeric articles. Non-limiting examples include dip molding, injection molding, blow molding, compression molding, thermoforming, and combinations thereof. In certain embodiments, seams may be formed by heat sealing, ultrasonic welding, adhesive bonding, or mechanical interlocks. In embodiments including an opening portion 204, the opening may be formed during molding or may be cut, slit, or otherwise post-processed and then fitted with a closure feature.

In some embodiments, the protective cover includes regions of different material properties to implement the retention regions and/or switch zones described herein. For example, a protective cover may be formed using multi-shot molding, overmolding, co-extrusion, or localized coatings to provide a higher-friction interior band, a stiffened reinforcement region, and/or a thinner switch zone. In some embodiments, exterior grip texture features (e.g., ribs, bumps, or other irregularities) are molded integrally, while interior features are formed as a distinct surface finish or as a localized insert/coating.

In one embodiment, the protective cover (100, 200, 300, 400, 500, 600) is fabricated using a hybrid rubber compound, comparable to materials employed in rubber gloves. This compound is designed to offer a service life ranging from a single day to several days, enabling the protective cover to be easily replaced as it becomes dirty. The hybrid material strikes a balance between durability and disposability, ensuring that the cover withstands regular use without tearing or failing prematurely, while remaining an economical, single-use solution for maintaining cleanliness.

In another embodiment, the protective cover (100, 200, 300, 400, 500, 600) is configured with sufficient elasticity to adhere fully to all parts of the control device 102. This elasticity ensures that the cover does not slip or slide under operational pressure, maintaining its position during use. At the same time, the cover is engineered not to exert excessive pressure on the control device, thereby avoiding the inadvertent activation of control switches or interference with device functionality. The result is a protective cover that effectively safeguards the control device from external contaminants while preserving its operational integrity.

In yet another embodiment, the protective cover (100, 200, 300, 400, 500, 600) is constructed from a combination of nitrile and latex. This material composition combines the stretchability and strength of latex with the puncture resistance and durability of nitrile, providing a robust solution that minimizes the risk of tearing during extended use. The protective covers are designed to endure hours of operation, with the need for replacement driven primarily by cleanliness concerns rather than material failure.

The protective cover (100, 200, 300, 400, 500, 600) offers substantial advantages as a disposable solution for protecting control devices 102 from contaminants such as mud, grease, and dirt. Once soiled, the protective cover can be conveniently replaced with a new one, ensuring the device remains clean and fully functional. The use of such covers prevents contamination from compromising the device's operational integrity, thereby extending its lifespan and reducing maintenance requirements.

Although the features, functions, components, and parts have been described herein in accordance with the teachings of the present disclosure, the scope of coverage of this invention is not limited thereto. On the contrary, this description covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

We claim:

1. A protective cover for a control device having a control portion and an elongated shaft extending from the control portion, the protective cover comprising:
a unitary, flexible elastomeric body defining a cavity configured to receive the control portion and a sleeve configured to extend along the shaft;
wherein the cavity has an internal cavity region sized to overlay the control portion and an internal retention region having a smaller effective inner diameter than the internal cavity region; and
wherein the internal retention region is positioned to engage a transition between the control portion and the shaft to resist axial migration of the protective cover during manual operation of the control device.

2. The protective cover of claim 1, wherein the internal retention region comprises an internal collar extending circumferentially around the cavity.

3. The protective cover of claim 1, wherein the internal retention region comprises a stepped inner diameter defined by a shoulder facing toward the sleeve.

4. The protective cover of claim 1, wherein an interior surface of at least one of the cavity or the sleeve includes an interior texture configured to increase friction relative to the control device.

5. The protective cover of claim 1, wherein an exterior surface of the protective cover includes an exterior grip texture comprising ribs, bumps, or surface irregularities configured to enhance grip.

6. The protective cover of claim 1, further comprising a switch zone on the cavity configured to overlie a control on the control portion, wherein the switch zone has a wall thickness less than an adjacent wall thickness of the cavity.

7. The protective cover of claim 6, wherein the switch zone has a wall thickness at least 20% less than the adjacent wall thickness of the cavity.

8. A protective cover for a control device, comprising:
a flexible cover body configured to cover at least a portion of the control device;
an opening feature extending along the flexible cover body to permit lateral placement of the flexible cover body around the control device;
an overlapping flap adjacent the opening feature; and
a closure feature comprising a pressure-sensitive adhesive portion positioned to secure the overlapping flap over the opening feature to retain the opening feature in a closed condition after placement on the control device.

9. The protective cover of claim 8, wherein the opening feature comprises a slit extending along the flexible cover body.

10. The protective cover of claim 8, wherein the closure feature further comprises a removable release strip covering the pressure-sensitive adhesive portion prior to use.

11. The protective cover of claim 8, wherein the overlapping flap provides an overlap region defining a tortuous path configured to inhibit ingress of contaminants through the opening feature.

12. A protective cover for a control device having a control box and a control arm extending from the control box, the protective cover comprising:
a flexible cover body configured to cover at least a portion of the control box; and
a passage portion defining an aperture configured to receive the control arm such that the flexible cover body covers the control box while the control arm extends through the aperture;
wherein the passage portion includes an elastomeric seal region configured to conform around the control arm to inhibit ingress of contaminants toward the control box.

13. The protective cover of claim 12, wherein an interior surface of the flexible cover body includes an interior high-friction region positioned to contact an exterior surface of the control box to reduce shifting of the protective cover relative to the control box during operation.

14. The protective cover of claim 13, wherein the flexible cover body comprises at least one additive selected from an antimicrobial agent, an antiseptic agent, or an allergen-reducing feature.

15. The protective cover of claim 1, wherein the control device is part of an operator console or remote control for a medical device, including a robotic surgical system.
